(19) United States
(12) Patent Application Publication
(10) Pub. No.: US 2002/0195504 A1
(43) Pub. Date: Dec. 26, 2002

(54) Structure of a squared multiple-section nozzle with rounded edges for spreading of water flow

(76) Inventor: Fanping Chen, Taipei (TW)

Correspondence Address: BACON & THOMAS, PLLC, 625 SLATERS LANE, FOURTH FLOOR, ALEXANDRIA, VA, 22314

(21) Appl. No.: 09/885,956

(22) Filed: Jun. 22, 2001

(51) Int. Cl. B05B 1/26; B05B 1/14; F23D 14/68

(52) U.S. Cl. 239/505; 239/590; 239/601

(57) ABSTRACT

The present invention relates to an improved structure of a squared multiple-section nozzle with rounded edges for spreading of water flow, especially one improving squared nozzles used in dyeing machines. The invention mainly adjusts size of opening between diameter of fabric passage and spraying hole of square nozzle. The diameter of fabric passage is squared with rounded edges and the spraying hole is used for spreading of water flow. Hence, the present invention is very convenient as fabrics of different thickness can be used without changing nozzles and thus preventing creases.

### TECHNICAL FIELD

The present invention relates to an improved structure of a squared multiple-section nozzle with rounded edges for spreading of water flow, especially one improving squared nozzles used in dyeing machines.

### INVENTION BACKGROUND

Different nozzles have to be changed for different fabric thickness in commonly used dyeing machines, the difference relating to the size of opening between the diameter of fabric passage and spraying hole of square nozzle. However, continuous changing of nozzles influences working efficiency and therefore, needs much to be improved.

As mentioned above, nozzles have to be changed in commonly used dyeing machines and this process wastes much time and energy.

Further, the diameter of fabric passage in commonly used squared nozzles dyeing machines has straight edges causing creases in fabrics and hence, influencing quality of fabric.

### SUMMARY OF THE INVENTION

The present invention relates to an improved structure of a squared multiple-section nozzle with rounded edges for spreading of water flow, especially one improving straight edges of diameter of fabric passage of squared nozzles.

The present invention relates to an improved structure of a squared multiple-section nozzle with rounded edges for spreading of water flow, especially one improving flow of dyeing solution and spreading of water flow in order to prevent creases in fabric.

Further, the present invention relates to an improved structure of a squared multiple-section nozzle with rounded edges for spreading of water flow, especially one adjusting sizes of opening between diameter of fabric passage and spraying hole of nozzles.

### DESCRIPTION OF DRAWINGS

FIG. 1 shows a plan of the commonly used structure.

FIG. 2 shows a plan of commonly used nozzles.

FIG. 3 shows a plan of the dyeing machine of the present invention.

FIG. 4 shows a top view of the dyeing machine.

FIG. 5 shows a front view of the nozzle structure.

FIG. 6 shows a sectional view of the nozzle structure.

FIG. 7 shows a plan of the dyeing solution spraying hole.

FIG. 8 shows a top view of the nozzle structure.

FIG. 9 shows the flowing state of fabric.

### NUMERICALS

10-dyeing machine

11-machine head

12-upper dyeing tube

13-nozzle

14-dyeing tube

101-window

23-nozzle

24-nozzle

33-nozzle

34-nozzle

203-fabric filling

204-fabric filling

303-fabric filling

304-fabric filling

213-dyeing opening

214-dyeing opening

313-dyeing opening

314-dyeing opening

50-dyeing machine

51-machine head

52-upper dyeing tube

53-square nozzle

54-turning plate

55-adjusting bar

56-cogwheel

60-multiple-section nozzle adjusting device

63-V-shaped path

64-V-shaped fabric passage

65-flexible plate

66-dyeing solution spraying hole

67-rack

68-diameter of fabric passage

69-rounded edges

70-fabric

71-spreading of water flow

72-water spreading opening

73-outward conducting body

### BEST MODE FOR CARRYING OUT THE INVENTION

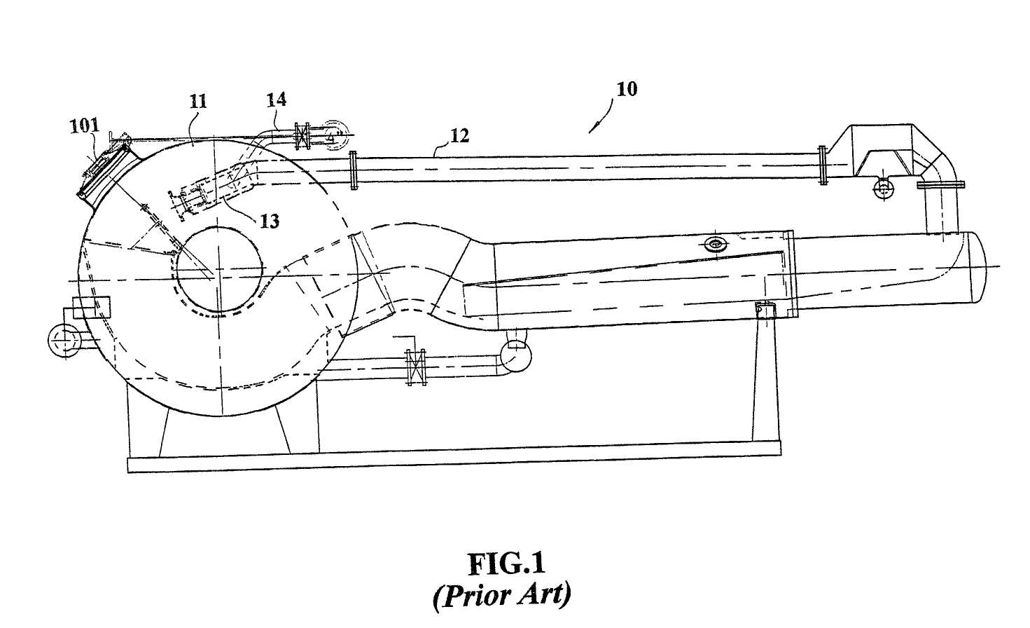

With reference to FIG. 1 showing a plan of the commonly used structure, a nozzle 13 is connected to upper dyeing tube 12 inside machine head 11 of dyeing machine 10. The nozzle 13 is usually locked to the front part of dyeing tube 12 and can be taken out at any time for cleaning and maintenance. Although the nozzle 13 is particularly designed, leaking or misconnection to dyeing tube can still happen and will thus influence work progress as the machine has to be stopped and allowed to cool down in order to open the window 101 of machine head 11 and change nozzle 13. Hence, man power as well as time is wasted influencing work efficiency.

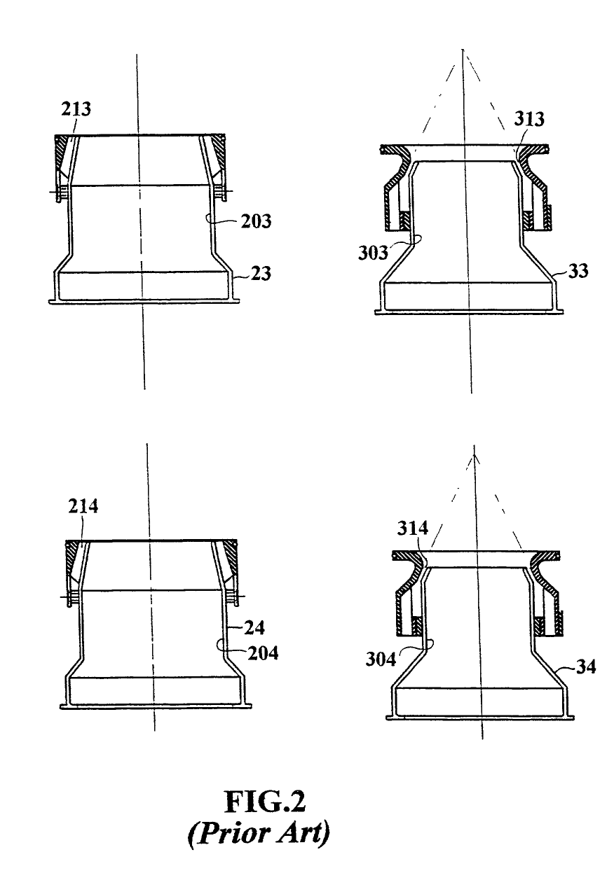

With reference to FIG. 2 showing a plan of the commonly used nozzle, fabric fillings 203, 204, 303 and 304 of right nozzles 23, 24 and left nozzles 33, 34 are different in sizes accordingly to dyeing openings 213, 214, 313 and 314 for different fabric thickness.

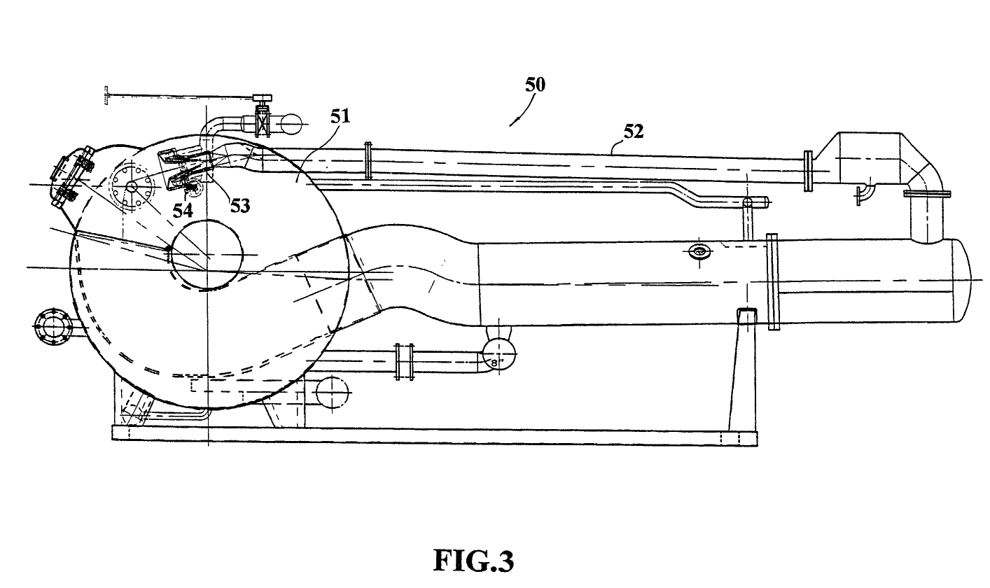

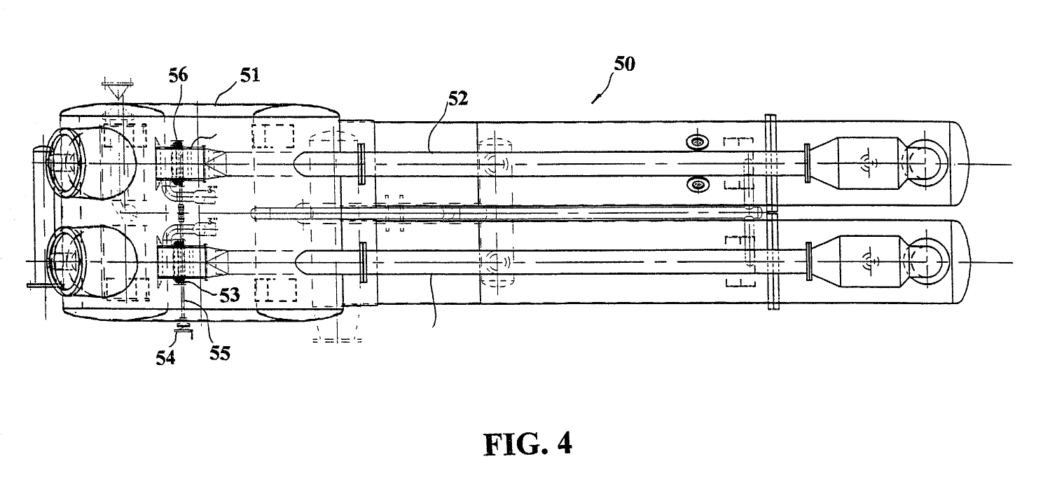

With reference to FIG. 3 showing a plan of the dyeing machine of the present invention, a square nozzle 53 is connected to the front part of the upper dyeing tube 52 found in the machine head 51 of the dyeing machine 50. Fabric goes through the square nozzle fixed to the upper dyeing tube 52 and can be adjusted according to different fabric sizes by means of an adjusting plate 54 (Please refer to FIG. 4), adjusting bar 55 and cogwheel 56.

With reference to FIG. 4 showing a top view of the dyeing machine, the square nozzle 53 found inside machine head 51 is adjusted by means of an adjusting plate 54, adjusting bar 55 and cogwheel 56.

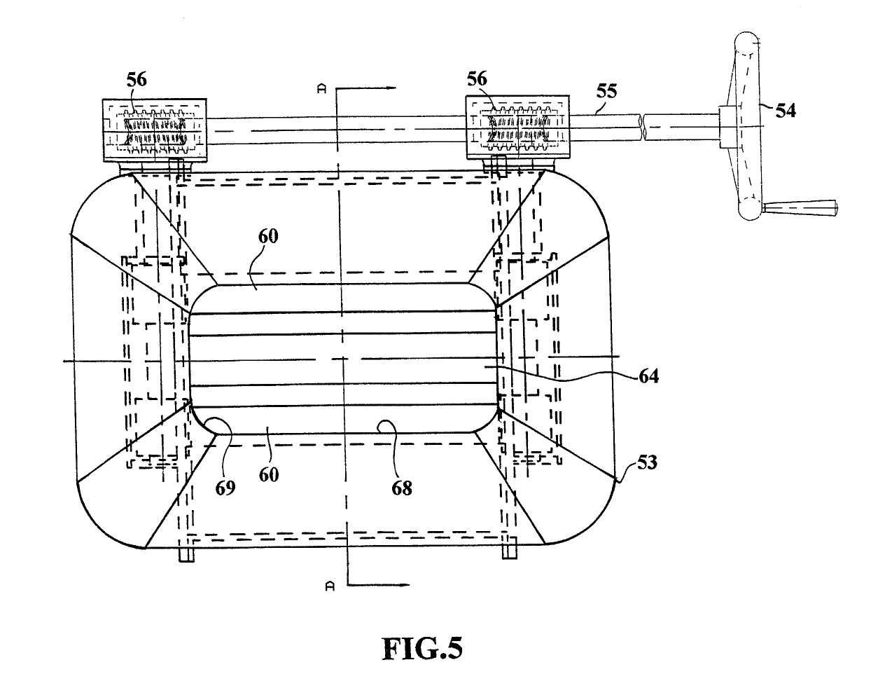

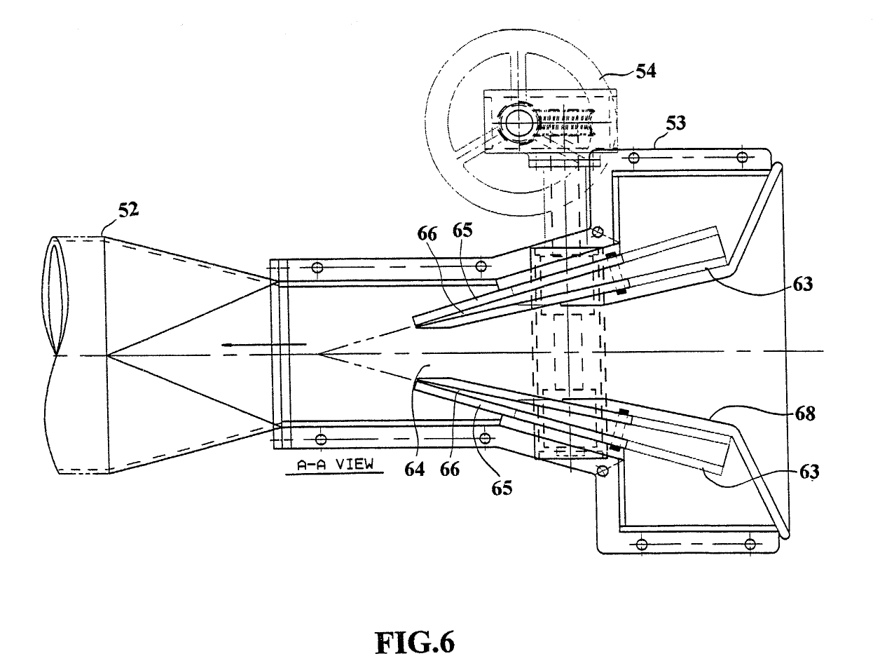

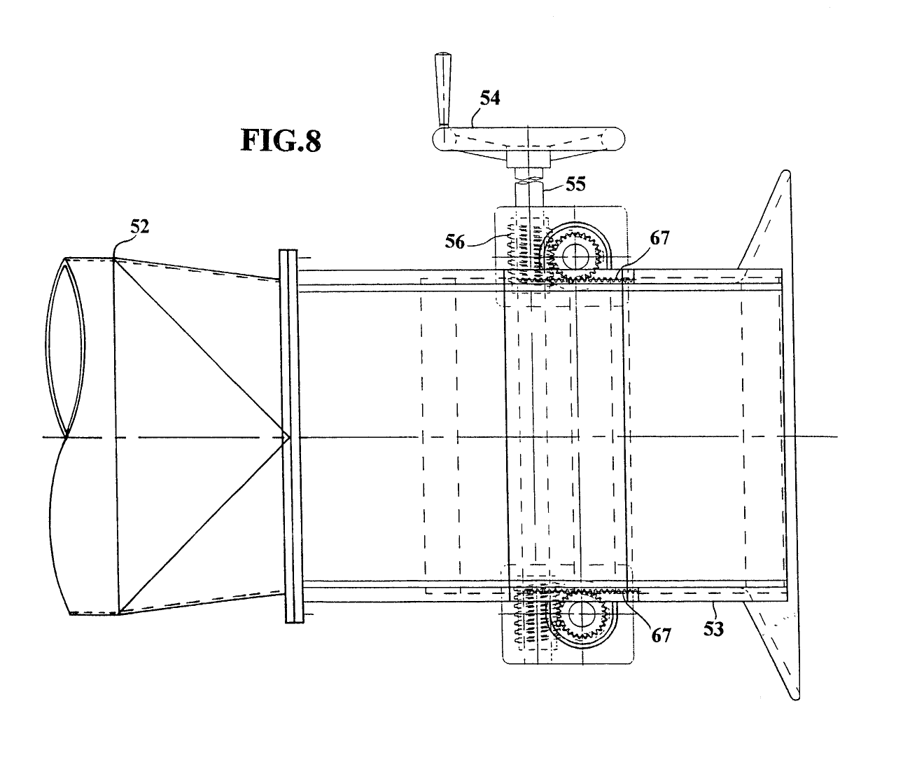

With reference to FIG. 5, FIG. 6 and FIG. 8, the structure mainly consists of a square nozzle 53, a group of multiple-section nozzle adjusting device 60 and an adjusting bar 55. A V-shaped path 63 is designed at both sides of the square nozzle 53 connected to multiple-section nozzle adjusting device 60 and a V-shaped fabric passage 64 with rounded edges 69 at the diameter of fabric passage 68 is left in the middle. The multiple-section nozzle adjusting device 60 consists of a group of flexible plates 65 along V-shaped path 63 for adjusting the opening between the V-shaped fabric passage and the dyeing solution spraying hole. The adjusting bar 55 is connected to the square nozzle 53 and uses a cogwheel to connect to the rack 67 found at both sides of the flexible plate 65. Hence, the size of opening of the nozzles can be adjusted according to different thickness of fabric.

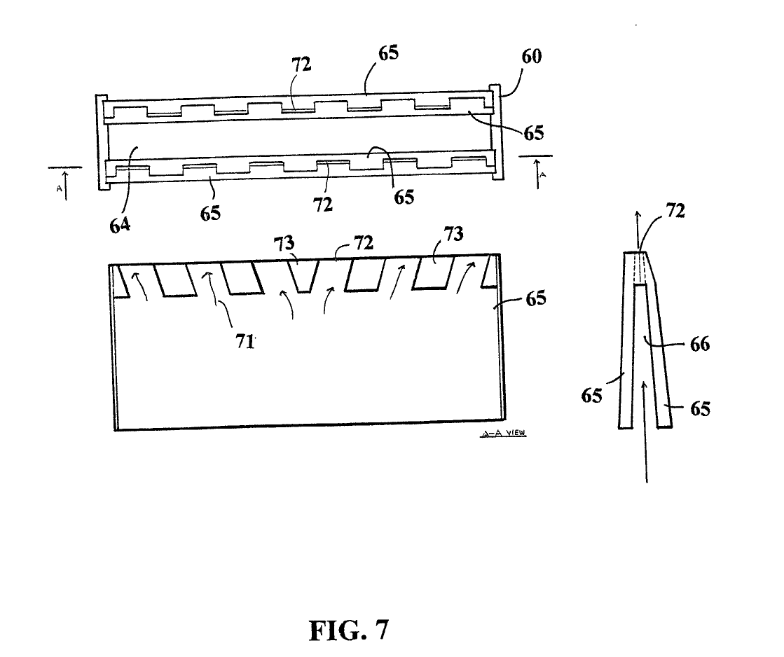

With reference to FIG. 7 showing a plan of the dyeing solution spraying hole, the spreading of water flow 71 of the dyeing solution spraying hole 66 is conducted by several outward conducting body 73 found inside the flexible plate 65 and form a V-shape leaving a water spreading opening 72. Hence, the direction of the dyeing solution spraying hole 66 to fabric 70 is not straight and forms a V-shape for spreading of water flow 71 thus improving quality of fabric 70.

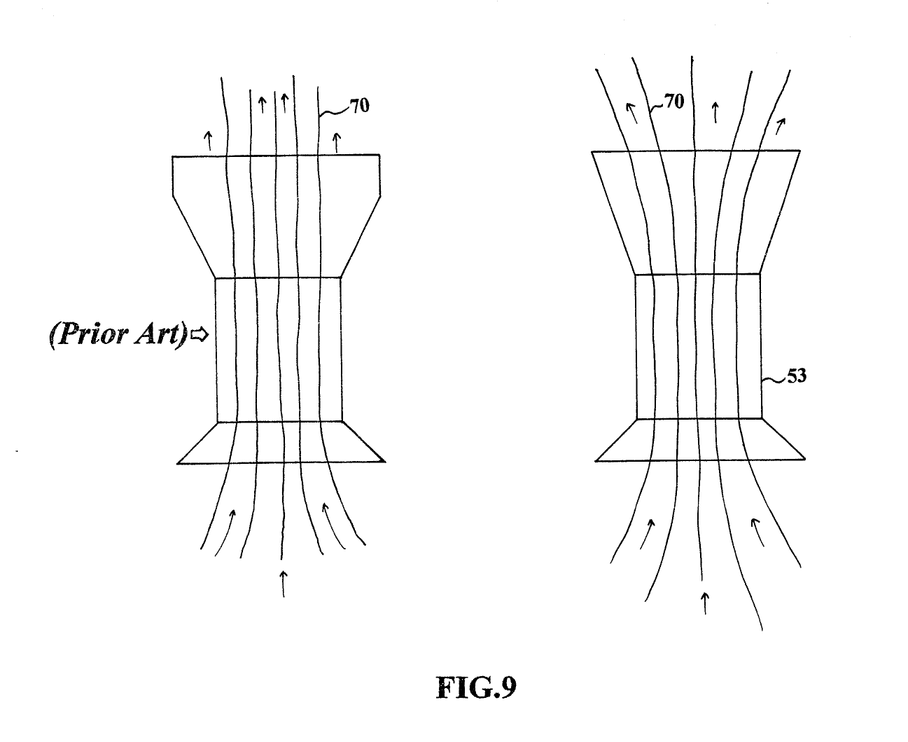

With reference to FIG. 9 showing the flowing state of fabric, the diagram on the left shows the common flowing state of fabric where the direction of the dyeing spraying hole is straight whereas the diagram on the right shows the spreading of the fabric from both sides thus improving quality of fabric as creases caused by pressure are hence prevented.

1. A kind of improved structure of a squared multiple-section nozzle with rounded edges for spreading of water flow mainly consisting of a square nozzle, a group of multiple-section nozzle adjusting device, an adjusting bar, rounded edges and several outward conducting bodies with the following characteristics:
A V-shaped path is found at both sides of square nozzle connected to multiple-section nozzle adjusting device and leaving a V-shaped fabric passage in the middle;
The multiple-section nozzle adjusting device consists of a flexible plate along V-shaped path and adjusts the opening between the V-shaped fabric passage and the dyeing solution spraying hole;
The adjusting bar is connected horizontally to the square nozzles and uses a cogwheel to connect to the rack at both sides of the flexible plates; The diameter of the V-shaped fabric passage has rounded edges; The outward conducting bodies are arranged separately in the dyeing solution spraying hole of the flexible plate and form a V-shape leaving a spraying opening.
